(19) United States
(12) Patent Application Publication
(10) Pub. No.: US 2022/0301757 A1
(43) Pub. Date: Sep. 22, 2022

(54) PLANAR COIL, AND TRANSFORMER, WIRELESS POWER TRANSMITTER, AND ELECTROMAGNET PROVIDED WITH SAME

(71) Applicant: KYOCERA Corporation, Kyoto-shi, Kyoto (JP)

(72) Inventor: Takeshi MUNEISHI, Kusatsu-shi, Shiga (JP)

(21) Appl. No.: 17/641,722

(22) PCT Filed: Aug. 19, 2020
(86) PCT No.: PCT/JP2020/031344

§ 371 Date: Mar. 9, 2022

(30) Foreign Application Priority Data
Sep. 10, 2019 (JP) 2019-164587

(51) Int. Cl. H01F 27/28; H01F 27/24; H01F 7/20; H02J 50/10

(52) U.S. Cl. CPC H01F 27/2804; H01F 27/24; H01F 7/20; H02J 50/10

(57) ABSTRACT

A planar coil (10) of the present disclosure includes a base (1) having a first surface (1a) and including a magnet material, and a first metal layer (2a) located on the first surface (1a) and having voids (3).

### TECHNICAL FIELD

The present disclosure relates to a planar coil, and a transformer, a wireless power transmitter, and an electromagnet provided with the same.

### BACKGROUND ART

A planar coil is acquired by forming a metal layer on an insulating base. For example, Patent Document 1 discloses a laminated coil in which a coil pattern is formed on an insulating substrate by electroplating.

### CITATION LIST

### Patent Literature

Patent Document 1: JP 2006-33953 A

### SUMMARY OF INVENTION

A planar coil of the present disclosure includes a base having a first surface and including a magnet material, and a first metal layer located on the first surface and having voids.

### BRIEF DESCRIPTION OF DRAWINGS

FIG. 1 is a plan view of an example of a planar coil of the present disclosure when viewed from a first surface side.

FIG. 2 is a diagram illustrating an example of a cross-sectional view taken along line A-A′ in FIG. 1.

FIG. 3 is a diagram illustrating an example of an enlarged view in a S portion illustrated in FIG. 2.

FIG. 4 is a diagram illustrating an example of an enlarged view in the S portion illustrated in FIG. 2.

FIG. 5 is a diagram illustrating an example of a cross-sectional view taken along line A-A′ in FIG. 1.

FIG. 6 is a plan view of another example of a planar coil of the present disclosure when viewed from a first surface side.

FIG. 7 is a diagram illustrating an example of a cross-sectional view taken along line B-B′ in FIG. 6.

FIG. 8 is a diagram illustrating an example of a cross-sectional view taken along line B-B′ in FIG. 6.

FIG. 9 is a diagram illustrating an example of a cross-sectional view taken along line B-B′ in FIG. 6.

FIG. 10 is a diagram illustrating an example of a cross-sectional view taken along line B-B′ in FIG. 6.

FIG. 11 is a plan view of another example of the planar coil of the present disclosure when viewed from a second surface side.

FIG. 12 is a diagram illustrating an example of a cross-sectional view taken along line C-C′ in FIG. 11.

FIG. 13A is a perspective view of a transformer of the present disclosure.

FIG. 13B is a cross-sectional view taken along line D-D′ in FIG. 13A.

FIG. 13C is a plan view of a first surface of a planar coil.

FIG. 13D is a plan view of a first surface of a planar coil.

FIG. 14A is a perspective view of a wireless power transmitter of the present disclosure.

FIG. 14B is a cross-sectional view taken along line E-E′ in FIG. 14A.

FIG. 14C is a plan view of a first surface of a planar coil.

FIG. 15 is a perspective view of an electromagnet of the present disclosure.

### DESCRIPTION OF EMBODIMENTS

A planar coil is acquired by forming a metal layer on an insulating base. For example, a laminated coil having a coil pattern formed by electroforming plating on an insulating substrate is disclosed. On the other hand, when such a laminated coil is used as a coil, since current flows through the metal layer, the metal layer easily generates heat. Therefore, it is expected to implement a planar coil having high heat dissipation.

A planar coil of the present disclosure, and a transformer, a wireless power transmitter, and an electromagnet provided with the same will be described in detail below with reference to the drawings.

It is noted that the drawings are schematic and the dimensional relationship between elements, the proportions of elements, and the like may differ from realistic ones. Furthermore, even between the drawings, there may be a case where portions having different dimensional relationships, proportions, and the like from one another are included.

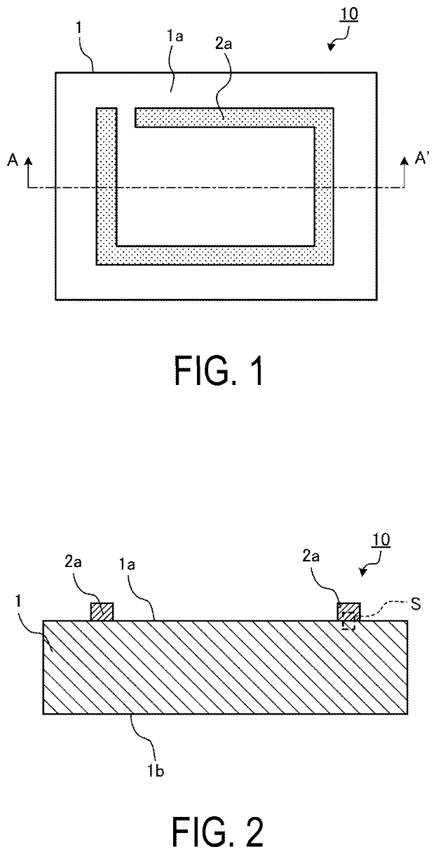

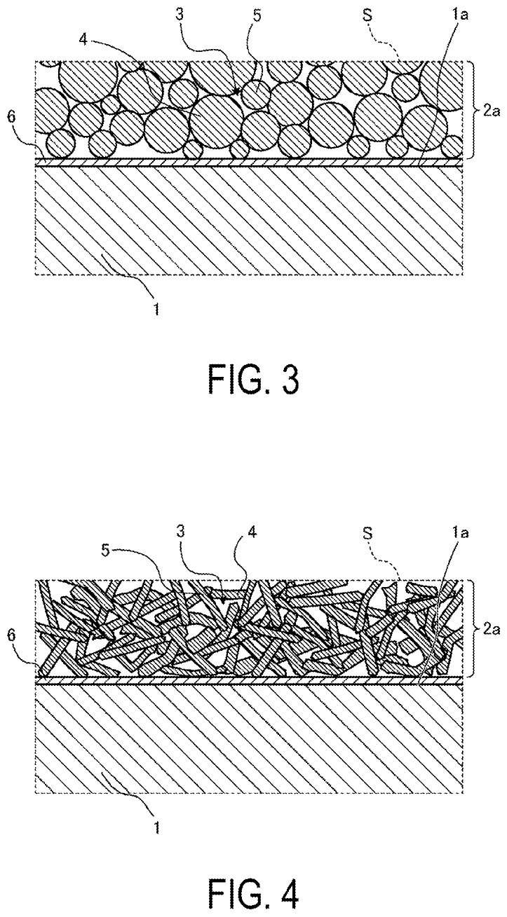

As illustrated in FIGS. 1 and 2, a planar coil 10 of the present disclosure includes a base 1 having a first surface 1a. Furthermore, the planar coil 10 includes a first metal layer 2a located on the first surface 1a. Furthermore, the first metal layer 2a includes a plurality of voids 3 (see FIG. 3).

The base 1 in the planar coil 10 of the present disclosure includes at least a magnetic material. Furthermore, all materials of the base 1 in the planar coil 10 of the present disclosure may be magnetic materials.

For example, the magnetic material has magnetism, or has magnetism by an external magnetic field. Examples of the magnetic material include ferrite, iron, silicon iron, iron-nickel based alloys, and iron-cobalt based alloys. Permalloy is an example of an iron-nickel based alloy. Furthermore, permendur is an example of an iron-cobalt based alloy.

Examples of the base 1 including the magnetic material include ceramics including various magnetic materials described above. Examples of the ceramics include aluminum oxide ceramics, silicon carbide ceramics, cordierite ceramics, silicon nitride ceramics, aluminum nitride ceramics, mullite ceramics, and the like. Examples of ceramics including the magnetic materials include silicon carbide including iron, and the like.

The base 1 may be used as a magnetic core (core).

As illustrated in FIGS. 1 and 2, the base 1 may have a plate shape. The base 1 may include the first surface 1a and a second surface 1b located on an opposite side of the first surface 1a. Furthermore, the first metal layer 2a may be located on the first surface 1a of the base 1 in a meandering shape or a spiral shape. Furthermore, the first metal layer 2a may be positioned on the first surface 1a of the base 1 in any arrangement.

As illustrated in FIG. 3, the first metal layer 2a includes the voids 3. Therefore, the surface area of the first metal layer 2a is larger than that of a metal layer having no voids. Consequently, the planar coil 10 has high heat dissipation.

Furthermore, as illustrated in FIG. 3, the first metal layer 2a may include first metal particles 4 and second metal particles 5. The voids 3 may be located between the first metal particles 4 and the second metal particles 5. With such a configuration, heat generated by the first metal particles 4 and the second metal particles 5 is absorbed by the voids 3, so that the planar coil 10 has high heat dissipation.

Materials of the first metal particles 4 and the second metal particles 5 constituting the first metal layer 2a may be, for example, stainless steel or copper.

As illustrated in FIGS. 3 and 4, the first metal particles 4 and the second metal particles 5 may each have a spherical shape, a granular shape, a whisker shape, or a needle shape, for example. When the first metal particles 4 and the second metal particles 5 each have a whisker shape or a needle shape, the first metal particles 4 and the second metal particles 5 may be bent. The first metal particles 4 and the second metal particles 5 may each include corners. When the first metal particles 4 and the second metal particles 5 each have a spherical shape or a granular shape, the longitudinal lengths of the first metal particles 4 and the second metal particles 5 may be 0.5 μm or more and 200 μm or less. When the first metal particles 4 and the second metal particles 5 each have a whisker shape or a needle shape, the diameter may be 1 μm or more and 100 μm or less, and the length may be 100 μm or more and 5 mm or less.

In FIG. 3, the first metal particles 4 and the second metal particles 5 each have a granular shape. In FIG. 4, the first metal particles 4 and the second metal particles 5 each have a whisker shape.

Furthermore, an average thickness of the first metal layer 2a may be 1 μm or more and 5 mm or less.

Furthermore, a porosity of the first metal layer 2a may be, for example, 10% or more and 90% or less. The porosity is an index representing the proportion of the voids 3 in the first metal layer 2a, and the porosity of the first metal layer 2a may be calculated by measurement using the Archimedes method.

Furthermore, as illustrated in FIGS. 3 and 4, the planar coil 10 of the present disclosure may include a bonding layer 6 located between the first metal layer 2a and the first surface 1a. With such a configuration, the first metal layer 2a is less likely to be peeled off from the base 1. Furthermore, the bonding layer 6 easily relieves stress generated by the difference in thermal expansion coefficients between the first metal layer 2a and the base 1. Therefore, cracks are less likely to occur in the base 1. Consequently, the planar coil 10 of the present disclosure can withstand long-term use. An average thickness of the bonding layer 6 may be 1 μm or more and 0.5 mm or less.

Furthermore, the bonding layer 6 in the planar coil 10 of the present disclosure may include resin or glass. As the resin, there is silicone or imide-amide, for example. As the glass, there is borosilicate glass or silicic acid-based glass, for example. When the bonding layer 6 includes the above material, the first metal layer 2a and the base 1 are firmly bonded, and the first metal layer 2a is less likely to be peeled off from the base 1.

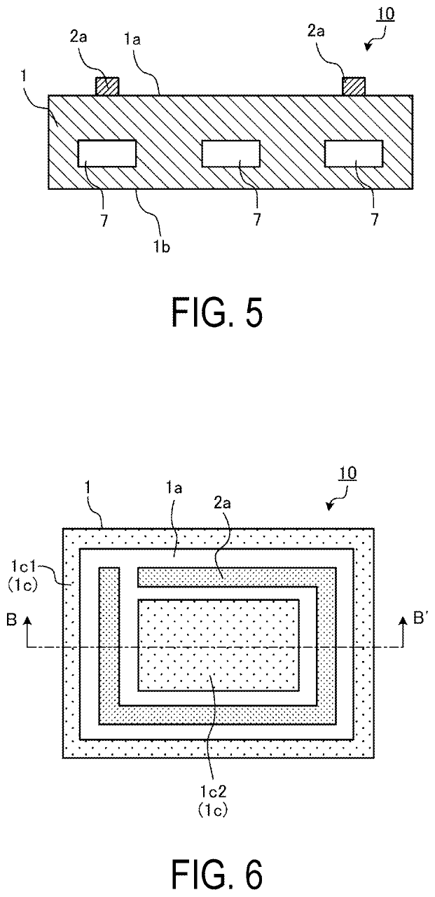

FIG. 5 is a diagram illustrating an example of a cross-sectional view taken along line A-A′ in FIG. 1. As illustrated in FIG. 5, the base 1 in the planar coil 10 of the present disclosure may include a channel 7 therein. With such a configuration, the temperature of the first metal layer 2a can be adjusted by flowing a fluid through the channel 7 of the base 1.

FIG. 6 is a plan view of another example of the planar coil 10 of the present disclosure when viewed from the first surface 1a side, and FIG. 7 is a diagram illustrating an example of a cross-sectional view taken along line B-B′ in FIG. 6. As illustrated in FIGS. 6 and 7, the base 1 in the planar coil 10 of the present disclosure may include a protruding portion 1c protruding from the first surface 1a. As illustrated in FIG. 7, the height of the protruding portion 1c is higher than that of the first metal layer 2a.

With such a configuration, when a plurality of the planar coils 10 are laminated to form a laminated coil, the protruding portion 1c is brought into contact with the base 1 of another laminated planar coil. Therefore, the plurality of planar coils 10 can be laminated without damaging the first metal layer 2a. When a second metal layer 2b is present on the second surface 1b, the base 1 may include the protruding portion 1c protruding from the second surface 1b.

Furthermore, as illustrated in FIG. 6, the protruding portion 1c in the planar coil 10 of the present disclosure may be located around the first metal layer 2a located on the first surface 1a. FIG. 6 illustrates an example in which the base 1 includes a protruding portion 1c1 having a frame shape in the plan view and a protruding portion 1c2 having a rectangular shape in the plan view, and the first metal layer 2a is located in a region surrounded by the protruding portion 1c1 and the protruding portion 1c2.

With such a configuration, the plurality of planar coils 10 can be stably laminated without damaging the first metal layer 2a.

As illustrated in FIG. 7, the planar coil 10 of the present disclosure may include an insulating layer 8 located between the first metal layer 2a and the first surface 1a. With such a configuration, even when the base 1 is made of a material having electrical conductivity such as iron, the first metal layer 2a is not short-circuited with the first metal layer 2a at another location by the base 1, and the first metal layer 2a can serve as a coil on the first surface 1a.

Furthermore, the insulating layer 8 in the planar coil 10 of the present disclosure may include glass, resin, or ceramics. As the glass, there is borosilicate glass or silicic acid-based glass, for example. As the resin, there is silicone or imide-amide, for example. Examples of the ceramics include aluminum oxide ceramics, silicon carbide ceramics, cordierite ceramics, silicon nitride ceramics, aluminum nitride ceramics, mullite ceramics, and the like.

In the present disclosure, the bonding layer 6 having an insulating property may be used as the insulating layer 8. Furthermore, in the present disclosure, when the base 1 has an insulating property, the insulating layer 8 may not be disposed.

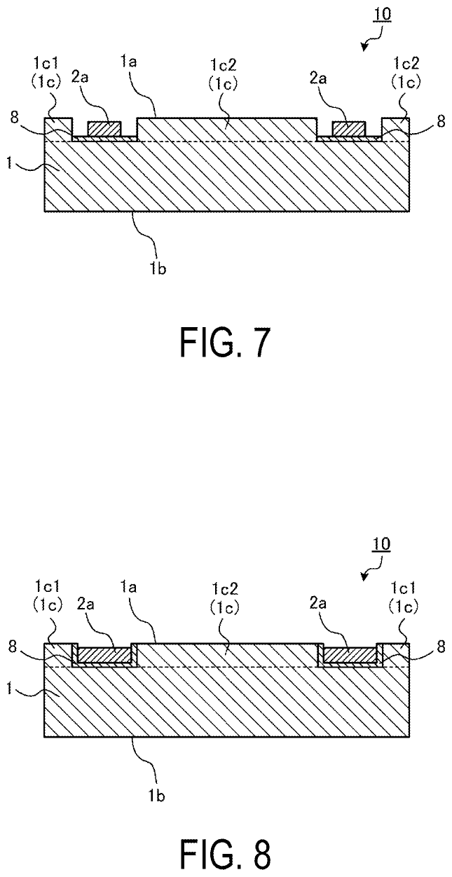

FIG. 8 is a diagram illustrating an example of a cross-sectional view taken along line B-B′ in FIG. 6. As illustrated in FIG. 8, the first metal layer 2a in the planar coil 10 of the present disclosure may be in contact with the side surface of the protruding portion 1c via the insulating layer 8.

With such a configuration, heat generated by the first metal layer 2a of the planar coil 10 can be efficiently transmitted to the protruding portion 1c, so that heat generated by the first metal layer 2a can be efficiently dissipated. Consequently, the planar coil 10 has a higher heat dissipation property.

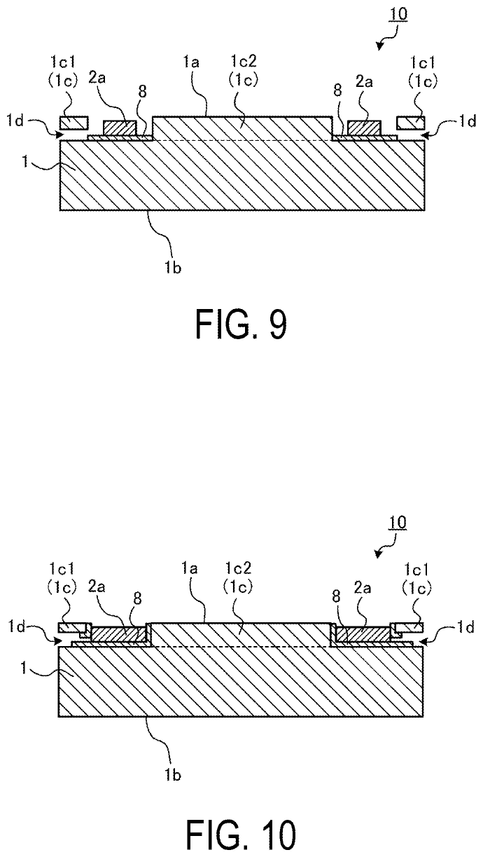

FIG. 9 is a diagram illustrating an example of a cross-sectional view taken along line B-B′ in FIG. 6. As illustrated in FIG. 9, the protruding portion 1c in the planar coil 10 of the present disclosure may include a through hole 1d penetrating in the thickness direction (lateral direction in FIG. 9) of the protruding portion 1c.

With such a configuration, a gas for cooling can flow from the through hole 1d toward the first metal layer 2a, so that the first metal layer 2a can be efficiently cooled. Consequently, the planar coil 10 has a higher heat dissipation property.

FIG. 10 is a diagram illustrating an example of a cross-sectional view taken along line B-B′ in FIG. 6. As illustrated in FIG. 10, the through hole 1d in the planar coil 10 of the present disclosure may include the insulating layer 8 on an inner wall surface facing the first metal layer 2a side.

With such a configuration, when a gas for cooling is flowed from the through hole 1d toward the first metal layer 2a, the gas can be accelerated at a portion where an inner diameter is reduced by the insulating layer 8, so that the gas can spread throughout the first metal layer 2a. Consequently, the planar coil 10 has a higher heat dissipation property.

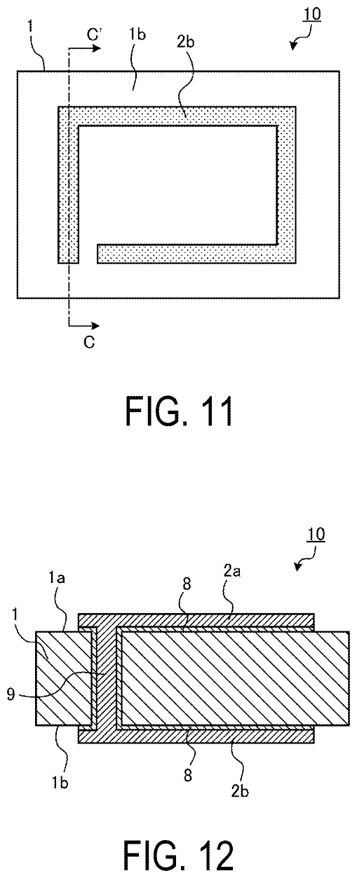

FIG. 11 is a plan view of another example of the planar coil 10 of the present disclosure when viewed from the second surface 1b side, and FIG. 12 is a diagram illustrating an example of a cross-sectional view taken along line C-C′ in FIG. 11. As illustrated in FIG. 12, the planar coil 10 of the present disclosure may include the first metal layer 2a located on the first surface 1a and the second metal layer 2b located on the second surface 1b.

As illustrated in FIG. 11, the second metal layer 2b may be located on the second surface 1b of the base 1 in a meandering shape or a spiral shape. The second metal layer 2b may be located on the second surface 1b of the base 1 in any arrangement. The second metal layer 2b may be made of the same material as that of the first metal layer 2a. That is, the second metal layer 2b may include the plurality of voids 3 (see FIG. 3), and may include the first metal particles 4 (see FIG. 3) and the second metal particles 5 (see FIG. 3).

With such a configuration, the base 1 including a magnetic material is located between a coil located on the first surface 1a and a coil located on the second surface 1b, so that the coils can be prevented from interfering with each other.

Furthermore, as illustrated in FIG. 12, the planar coil 10 of the present disclosure may include a via 9 that electrically connects between the first metal layer 2a located on the first surface 1a and the second metal layer 2b located on the second surface 1b. A material constituting the via 9 is metal, but may be the same material as that of the first metal particles 4 and the second metal particles 5 constituting the first metal layer 2a and the second metal layer 2b.

With such a configuration, the first metal layer 2a, the via 9, and the second metal layer 2b form one metal layer, and the length of the metal layer can be extended on the limited surface of the base 1.

Furthermore, as illustrated in FIG. 12, the planar coil 10 of the present disclosure may include the insulating layer 8 located between the first metal layer 2a and the first surface 1a, the insulating layer 8 located between the second metal layer 2b and the second surface 1b, and the insulating layer 8 located between the via 9 and the base 1.

With such a configuration, even when the base 1 is made of a material having electrical conductivity such as iron, the first metal layer 2a and the second metal layer 2b are not short-circuited with each other by the base 1, and the first metal layer 2a and the second metal layer 2b can serve as a coil.

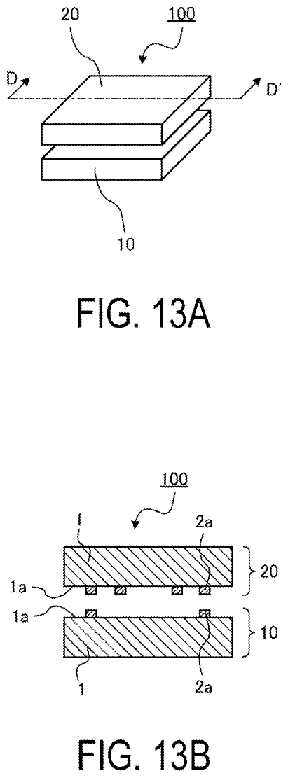

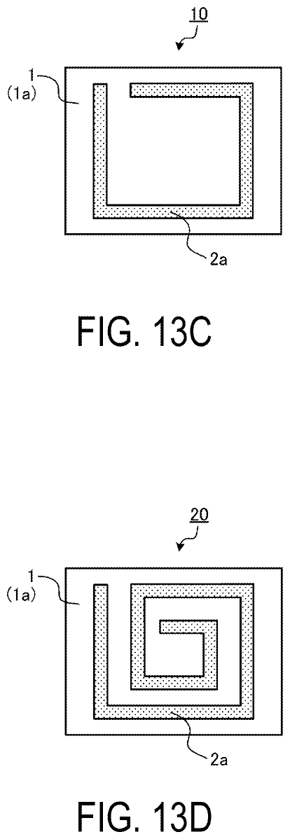

As illustrated in FIG. 13A, the planar coil 10 of the present disclosure may be provided in a transformer 100. The transformer 100 is provided with one or more planar coils 10 on a power supply side or a power supply and demand side, and can be the transformer 100 configured to convert voltage when current flows through the first metal layer 2a. As illustrated in FIGS. 13A and 13B, the transformer 100 may include the planar coil 10 on a power supply side. Furthermore, the transformer 100 may also include a planar coil 20 on a power supply and demand side. When an external power supply is connected to the planar coil 10 and current flows through the first metal layer 2a, electromagnetic induction is generated. Therefore, current flows through the first metal layer 2a of the planar coil 20. As illustrated in FIGS. 13C and 13D, the number of turns of the first metal layer 2a in the planar coil 10 may be different from that of the first metal layer 2a in the planar coil 20. By adjusting the number of turns in the planar coil 10 and the number of turns in the planar coil 20, voltage can be changed.

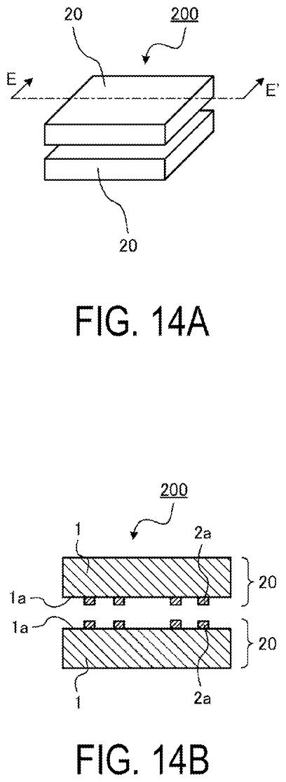

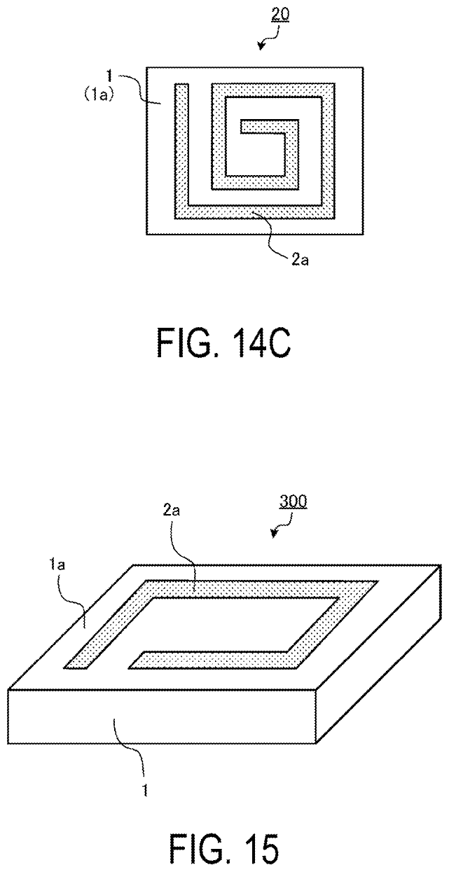

As illustrated in FIG. 14A, the planar coil 20 of the present disclosure may be provided in a wireless power transmitter 200. The wireless power transmitter 200 may include one or more planar coils 20 on a power supply side or a power supply and demand side. In this case, current flows through the first metal layer 2a, so that power can be transmitted. Therefore, the planar coil 20 of the present disclosure can be used as the wireless power transmitter 200. The wireless power transmitter 200 in FIGS. 14A and 14B may include the planar coil 20 provided on a power supply side, and the planar coil 20 provided on a power supply and demand side. When an external power supply is connected to the planar coil 20 and current flows through the first metal layer 2a, electromagnetic induction is generated. Therefore, current flows through the first metal layer 2a of the planar coil 20. In this way, the planar coil 20 of the present disclosure can be used as the wireless power transmitter 200 that delivers power.

As illustrated in FIG. 15, the planar coil 10 of the present disclosure may be provided in an electromagnet 300. The electromagnet 300 includes one or more planar coils 10, and when electricity is passed through the first metal layer 2a, a magnetic force is generated on a magnetic core. Therefore, the planar coil 10 of the present disclosure can be used as an electromagnet.

Next, an example of a method for manufacturing the planar coil of the present disclosure will be described.

First, the base 1 including a soft magnetic material is prepared. The channel 7 may be provided inside the base 1 including a soft magnetic material. Furthermore, the base 1 may include the protruding portion 1c and the through hole 1d.

Next, the first metal layer 2a is formed on the first surface 1a of the base. First, a mask made of resin and having a desired shape is formed on the first surface 1a. Next, for example, a liquid mixture in which a plurality of metal particles including the first metal particles 4 and the second metal particles 5 made of stainless steel or copper are mixed with a liquid such as water is prepared, and is poured into a space formed by the mask. Next, the liquid mixture is evaporated. Thereafter, the mask is removed by burning or using a solvent. Moreover, after pressurizing the base 1 with a predetermined pressure, the base 1 is heated or ultrasonically vibrated. With this, the first metal particles 4 and the second metal particles 5 are bonded to acquire the first metal layer 2a having the voids 3.

Instead of directly forming the first metal layer 2a on the first surface 1a of the base 1, the bonding layer 6 may be first formed on the first surface 1a, and then the first metal layer 2a may be formed on the bonding layer 6. The bonding layer 6 is resin or glass. On the other hand, when the bonding layer 6 is resin or glass, the bonding layer 6 is formed before the mask is formed. In this case, the bonding layer 6 is formed by applying a paste having the resin or glass as a main component to the first surface 1a and performing heat treatment. Furthermore, the resin or glass may be formed to cover the entire first surface 1a of the base 1.

Then, by forming the first metal layer 2a on the bonding layer 6 and heating the base 1, the bonding layer 6 gets wet and is bonded to the first metal layer 2a when the bonding layer 6 is resin or glass.

The first metal layer 2a may be separately prepared and placed on the bonding layer 6 formed in advance on the first surface 1a, or a paste to be the bonding layer 6 may be applied to the first metal layer 2a and placed on the first surface 1a, and then a base may be heated, thereby acquiring the base 1 including the first metal layer 2a. In this case, the first metal layer 2a is produced in advance by the following method. First, for example, a liquid mixture in which a plurality of metal particles made of stainless steel or copper are mixed with a liquid such as water is prepared, and is poured into a mold having a shape of the first metal layer 2a. Next, the liquid mixture is evaporated. Next, the first metal particles 4 and the second metal particles 5 are bonded by pressurizing at a predetermined pressure and heating or by ultrasonic vibration. Then, when it is taken out from the mold, the first metal layer 2a including the bonded first metal particles 4 and second metal particles 5 and the voids 3 is acquired. Furthermore, by inserting the insulating layer 8 into the through hole 1d, the insulating layer 8 can be formed on the inner wall surface facing the first metal layer 2a side.

The first metal layer 2a may be produced by the following method. First, after a plurality of metal particles including the first metal particles 4 and the second metal particles 5 are mixed with a binder, a molded body is produced by a mechanical pressing method. Next, the binder is evaporated by drying the molded body. Then, it is heated or ultrasonically vibrated. This allows the first metal particles 4 and the second metal particles 5 to be bonded to acquire the first metal layer 2a having the voids 3.

When the via 9 that electrically connects between the first metal layer 2a and the second metal layer 2b is provided, the following is performed. A paste in which a plurality of metal particles including the first metal particles 4 and the second metal particles 5 are mixed with a binder is prepared and embedded in a hole formed in advance in the base 1. At this time, a wall surfaces of the hole may be covered with glass or resin in advance. Then, by evaporating the binder through heat treatment after or before the first metal layer 2a and the second metal layer 2b are formed, the via 9 can be formed.

Note that the present disclosure is not limited to the above-described embodiment, and various modifications, enhancements, and the like may be made without departing from the scope of the present disclosure. Furthermore, in the present disclosure, components over different embodiments may be appropriately combined.

### REFERENCE SIGNS LIST

1 Base
1a First surface
1b Second surface
1c Protruding portion
1d Through hole
2a First metal layer
2b Second metal layer
3 Void
4 First metal particle
5 Second metal particle
6 Bonding layer
7 Channel
8 Insulating layer
9 Via
10, 20 Planar coil
100 Transformer
200 Wireless power transmitter
300 Electromagnet

1. A planar coil comprising:
a base comprising a first surface and a magnet material; and
a first metal layer located on the first surface and comprising voids.

2. The planar coil according to claim 1, wherein the base is a magnetic material.

3. The planar coil according to claim 1, wherein
the first metal layer comprises first metal particles and second metal particles, and
the voids are located between the first metal particles and the second metal particles.

4. The planar coil according to claim 1, further comprising:
a bonding layer located between the first metal layer and the first surface.

5. The planar coil according to claim 4, wherein the bonding layer comprises resin or glass.

6. The planar coil according to claim 1, wherein the base comprises a channel inside the base.

7. The planar coil according to claim 1, wherein
the base comprises a protruding portion protruding from the first surface, and
a height of the protruding portion is higher than a height of the first metal layer.

8. The planar coil according to claim 7, wherein the protruding portion is located around the first metal layer located on the first surface.

9. The planar coil according to claim 7, wherein the protruding portion comprises a through hole penetrating in a thickness direction of the protruding portion.

10. The planar coil according to claim 1, further comprising:
an insulating layer located between the first metal layer and the first surface.

11. The planar coil according to claim 1, further comprising:
a second metal layer located on a second surface facing the first surface in the base and comprising voids.

12. The planar coil according to claim 11, further comprising:
a via that electrically connects between the first metal layer and the second metal layer.

13. A transformer comprising:
the planar coil according to claim 1.

14. A wireless power transmitter comprising:
the planar coil according to claim 1.

15. An electromagnet comprising:
the planar coil according to claim 1.
